(19) United States
(12) Patent Application Publication
(10) Pub. No.: US 2009/0268030 A1
(43) Pub. Date: Oct. 29, 2009

(54) INTEGRATED VIDEO SURVEILLANCE AND CELL PHONE TRACKING SYSTEM

(75) Inventor: Tom Markham, Fridley, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NY (US)

(21) Appl. No.: 12/111,667

(22) Filed: Apr. 29, 2008

(51) Int. Cl. H04N 7/18

(52) U.S. Cl. 348/158; 348/159; 348/E07.085

(57) ABSTRACT

A system having cell phone tracking integrated with video surveillance. The system may have one or more cameras for surveillance of a subject. The system may also have a detection mechanism with one or more antennas for picking up signals from a source of electromagnetic radiation. The source may be associated with the subject. The detection mechanism may determine direction, location and/or identity of the source. The source may be a cell phone. The present system may have one or more OCR readers, phone number extractors, video analytics, watchlist checkers, processors, databases, interfaces, and so forth, for obtaining information about the subject.

### BACKGROUND

The present invention pertains to surveillance and particularly to surveillance of entities. More particularly, the invention pertains to surveillance of persons and vehicles.

### SUMMARY

The invention is an integrated cell phone tracking and video surveillance system.

### BRIEF DESCRIPTION OF THE DRAWING

FIG. 1 is a diagram of an integrated cell phone tracking and video surveillance system;

FIG. 2 is a diagram of phone tracking and video surveillance cell of the system;

FIG. 3 is a block diagram of the phone tracking and video surveillance system; and

FIG. 4 is a diagram of several phone tracking and video surveillance cells of the system.

### DESCRIPTION

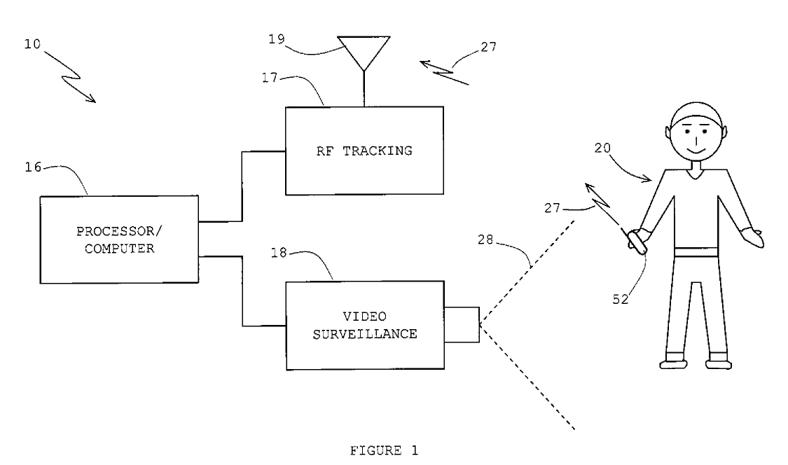

The present invention may include an integration of radio frequency (RF) tracking 17 with video surveillance 18 in system 10 shown in FIG. 1. The RF may be a signal 27 emanated by a cell phone 52 and detected by one or more antennas 19. The video surveillance 18 may include a camera having a field of view 28, for detecting an individual, person, vehicle or entity 20 who may be carrying or be proximate to cell phone 52. Cell phone tracking and video surveillance system 10 may take advantage of the growing popularity of cell phones. The present cell phone tracking/location system 10 may be used alone (RF only) or in conjunction with video (visible and/or infrared) surveillance 18 mechanism to locate, identify and track persons, vehicles or other entities 20 of interest. Integration of RF tracking 17 and video surveillance 18 may be integrated at least in part with a processor/computer 16. The term “present” used in this description may refer to the invention described herein.

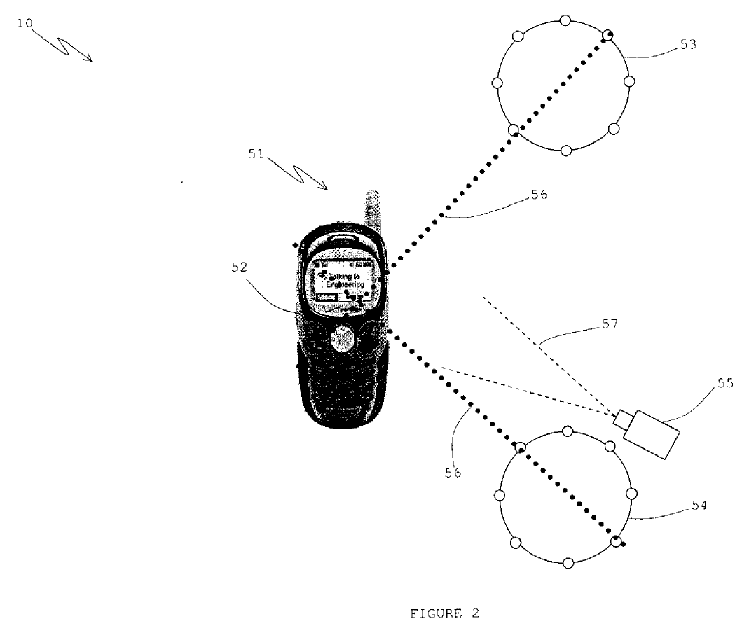

FIG. 2 shows a video and cell phone signal tracking aspect 51 of system 10. This aspect may include cell phone 52 which emits RF communication signals 56. Signals 56 may be used for identification and location of phone 52. The phone's signals might provide, at the same time, an identity and the whereabouts of a particular subject carrying the cell phone 52. A Doppler antenna 53 or 54 may detect direction and radial speed of phone 52 relative to the antennas. One of the Doppler antennas 53 and 54 may detect signals 56 for phone identification. Antennas 53 and 54 may be located in different places so as to provide a good basis for locating phone 52. Also, one or more video cameras 55 with a field of view 57 may be aimed or steered towards the source of the electromagnetic emissions 56 which may include a subject being tracked and possibly identified. The camera or cameras 55 may take and record video images of the subject. The track of a moving RF, radiation or emissions source may be correlated with the track of an entity moving in the video to improve the accuracy of association over static methods. There may be a track correlation mechanism for correlating the track of the moving radiation source with the track indicated by an image in order to associate the radiation source and image in cluttered environments. The image may be that of a subject or entity.

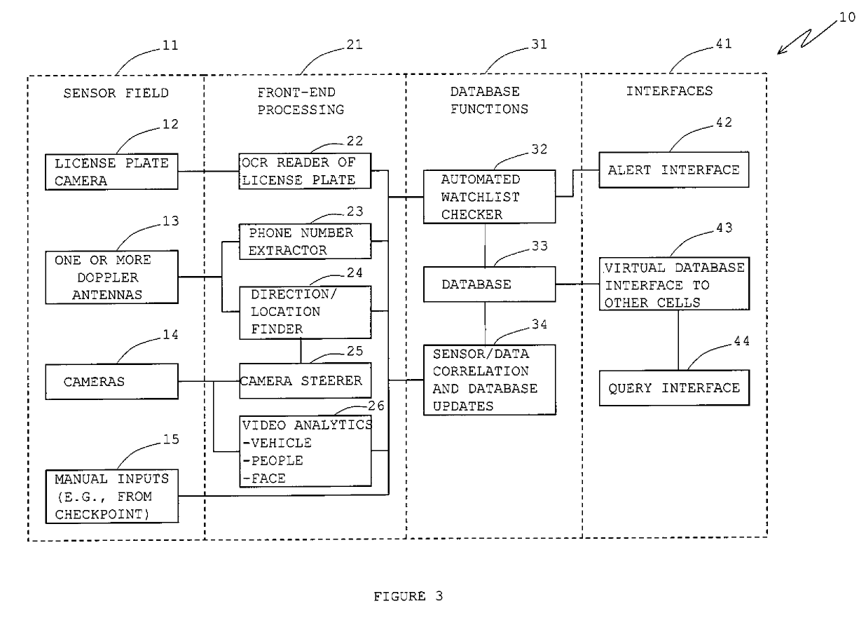

FIG. 3 is a block diagram showing a combination of various portions of an illustrated example of the present system 10. There may be other configurations of system 10. The present system 10 configuration may have a sensor field section 11, a front-end processing section 21, a database function section 31 and an interface section 41. The sensor field section 11 may include a license plate camera 12, one or more Doppler antennas 13, cameras 14 for acquiring images of a person, face and/or iris, or other entity, and a manual inputs (e.g., from a checkpoint) module 15. There may be other devices and mechanisms in the sensor field 11.

The front-end processing section 21 may include an optical character recognition (OCR) reader 22 for reading license plates or the like, a phone number extractor 23, a direction/location finder 24, a camera steerer 25 and a video analytics module 26. There may be other devices and mechanisms in the processing section 21.

OCR reader 22 may be connected to an output of the license plate camera 12. The phone number extractor 23 and direction/location finder 24 may be connected to the Doppler antenna pair 13. A detected cell phone 52 RF emissions may provide an ID of the phone via the number extractor 23. The RF emissions may also provide a basis for finder 24 to determine where phone 52 is situated. The camera steerer 25 may be connected to pan, tilt and zoom mechanisms of cameras 14, and the video analytics module 26 may be connected to the outputs of cameras 14. An output from the direction/location finder 24 may be connected to an input of the camera steerer 25. The location of phone 52 from finder 24 may cause steerer 25 to move the cameras 14 in a direction towards phone 52 to possibly obtain images of a holder of the phone 52. These images may be analyzed by analytics module 26 to obtain further information about a vehicle, person, face or iris associated with phone 52.

The data base function section 31 may have an automated watchlist checker module 32, a database 33 and a module 34 for sensor/data correlation and database updates. Outputs from the OCR reader 22, phone number extractor 23, direction/location finder 24, video analytics module 26, and the manual inputs module 25 may go to the automated watchlist check module 32 and to module 34 for sensor/data correlation and database updates. Database 33 may be connected to modules 32 and 34.

Module 32 and module 34 may seek a correlation of information from the analytics module 26, finder 24, phone number extractor 23 and OCR reader 22. Additional information may be obtained from or via database 33 from other video and phone tracking cells of system 10, for correlation by module 34 and watchlist checker 32. Information shared between cells may allow a phone or other entity to be tracked across multiple cells.

The interface section 41 may include an alert interface module 42, a module 43 for a virtual database interface to other cells, and a query interface 44. The alert interface module 42 may be connected to the automated watchlist checker module 32. Module 42 may provide alerts relative to particular matches, especially those that appear ominous, of information from modules of section 21 to the watchlist check module 32

The module 43 virtual database interface may be connected to database 33. Other cells of system 10, with one or more databases, may communicate with the database 33 via interface 43. The query interface 44 may be connected to module 43 for the virtual database interface to other cells for conducting information or matching inquiries to other cells of system 10.

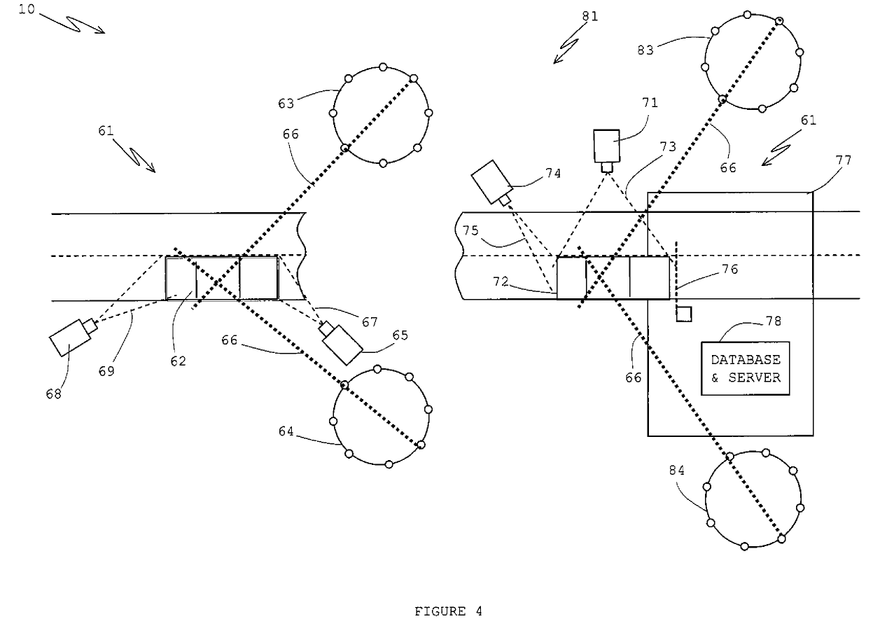

FIG. 4 shows an aspect 81 of system 10 which shows additional components, i.e., other cells, in view of aspect 51 of system 10. This aspect 81 may be illustrated as two cells 61 of system 10 deployed over a region. There may be more cells in system 10. Each cell may have its own sensors, sensor controls, video analytics and database. A cell 61 may reveal an example where a vehicle 62 may be tracked and identified at a first location. At this location, a camera 65 having a field of view 67 may capture images of vehicle 62. A cell phone 52 of FIG. 2 may be in vehicle 62. Cell phone 52 may emit RF signals 66 to be picked up by one or both Doppler antennas 63 and 64. Signals 66 detected by one or both antennas may provide an identity of the cell phone 52 and perhaps even of the person carrying the phone. Also, signals 66 may provide a basis for determining a location of the phone and also of the person and vehicle.

Another video camera 68 proximate to vehicle 62 may capture an image of a license plate on the vehicle 62 in a field of view 69. An OCR reader may convert the license plate image into an alpha-numeric text of the license plate number. An appropriate database may be queried with the license plate number for purposes of identifying vehicle 62, its owner and possibly the driver if different from the owner. Identifying information originating from the cell phone 52 signal 66 may provide corroboration of the license plate information.

Vehicle 62 may drop out of sight from the field of view 67 of camera 65. However, a vehicle 72 similar to vehicle 62 may show up at another location, perhaps some distance away from the location of vehicle 62. A sighting of vehicle 72 may be captured by another video camera 71 within its field of view 73. Vehicle 72, captured by camera 71, may look similar to vehicle 62 but it may not be the same vehicle since there could be many vehicles that look like vehicles 62 and 72. Again, signals 66 may be emitted from vehicle 72. These signals may be detected by antennas 83 and/or 84 and be determined by associated electronics to be a different or the same cell phone identified in vehicle 62. Also, another camera 74 with a field of view 75 may capture an image of the license plate and, with an OCR reader, the license plate number of vehicle 72 may be determined. The plate number of vehicle 72 may or may not be found to be the same as the plate number of vehicle 62. This comparative information might be sufficient to identify the vehicle and possibly the driver.

Vehicle 72 may be at a gate 76 attempting to gain entry into a facility 77. The cell phone identification, video images of the vehicle and its plate number, and possible video images of the driver and any other persons in the vehicle may be queried in a database 78 and other databases as needed to obtain corroborating information about vehicle 72. With such information, a decision as to whether to let vehicle 72 enter gate 76 to facility 77 may be made. Previous video images of vehicle 62 by cameras 65 and 68 may be pertinent to such decision. A check may be made to determine whether the previous images show vehicle 62 originating from a suspicious area. Other information from sources mentioned and not mentioned herein may be obtained for decision making concerning the vehicles 62 and 72, and possible persons associated with the vehicles. A primary factor of system 10 may be the integration of video image capture with cell phone identification and location for surveillance and tracking.

There may be situations in which persons should be tracked or identified for law enforcement or security purposes. For instance, a video camera may record someone committing an infraction, e.g., an unauthorized slipping through a gate at an airport. Such person of interest may be observed within the field of view of one camera but moves out of the field of view. Other cameras may need to be able to identify this person as the same one of interest when the person moves into the field of view of such other cameras. Many video cameras appear limited in their ability to meet the identification needs of a subject relative to it changing going from one field of view to another. In system 10, these video results may be strengthened or confirmed with integrated cell phone 52 tracking, since many persons carry cell phones.

In system 10, video images may be acquired via visible or IR light or a combination of IR and visible light from a subject of surveillance. The images may then be used for appearance models, face recognition, and so on. Various kinds of recognition software in the video analytics module 26 may be complemented, strengthened and corroborated with its association of information resulting within system 10 from cell phone 52 tracking.

Appearance models may show promise in identifying an individual or subject and tracking them across cameras 14, 18, 55, 65, 71 having non-overlapping fields of view. There appears to be a need to be able to correlate persons of interest across time as well. For example, a person wearing a red shirt may loiter around a school yard on Monday. On Wednesday a person wearing a blue shirt may loiter in the same area. The appearance models may be different but a question is whether it is the same person. Performing tracking and recognition using hybrid RF (i.e., cell phone 52 emissions 27, 56, 66) and video techniques may significantly improve the accuracy of a surveillance system 10 using appearance models.

There may be a one-to-one correspondence between cell phone 52 and the person who carries the phone. Cell phones may effectively be personal RF beacons. Thus, a cell phone 52 may broadcast its identity so that nearby cell towers can know how to route a call should there be an incoming call/message for that particular cell phone. When a person is carrying a cell phone 52, even if he or she is not talking on it, the phone may be broadcasting an identity (e.g., a phone number) and providing a signal which can be located and tracked using RF direction finding. The cell phone 52 identification (ID) information, together with direction finding, may be used to identify people of interest while at a distance even though they may be wearing different clothes or be in a different vehicle relative to a previous observation. Using two or more directional antennas (e.g., Adcock or Doppler), it may be possible to provide sufficient localization to guide a PTZ camera to a subject proximate to phone 52. This approach may then associate a cell phone ID with an image of the person or vehicle.

Leveraging cell phone 52 as a locating beacon may be critical to linking an RF signature to a video clip of an individual. A handset identifier may be broadcast to inform local cell towers of the phone's presence. There may be specifications that can then be used to determine how fingerprinting-unique-like data is encoded in the broadcast information. This may involve TDMA or CDMA encoding as well some error detection. Unique identifying information may be obtained from a TDMA signal. The CDMA codes may typically be broadcast from the cell tower down to the phone.

As to identification, a signal from the cell phone 52 may be decoded to determine the identifier (phone number) for the handset. As to correlation, the location and tracking data from an RF subsystem may be correlated with the location, motion detection, people detection and tracking data from a video subsystem. As to a handoff, the correlated video and cell phone identification data may be handed off to the next cell 51, 61, i.e., a set of sensors which are to monitor or track the same person of interest.

The present system 10 may collect an RF signature from a cell phone 52 and then fuse the RF signature with a video to more accurately track and recognize individuals or subjects. This may result in new capabilities such as recognizing an individual at a relatively long distance (e.g., 100 meters) using his or her cell phone signal, and then using the data to extract previously acquired images and an RF cell phone signature of the individual from a database.

System 10 may consist of the following items. As to direction finding, each antenna 13, 19, 53, 54, 63, 64, 83, 84 in the system may determine the direction of the cell phone 52 relative to the location of the antenna. As to location, information from two or more sensors (i.e., a camera and an antenna, or multiple antennas, or even multiple antennas and multiple cameras) may be mathematically combined to locate a source of the cell phone transmission. The location may adequately be determined in two dimensions but it may be possible to locate the source of the transmission in three dimensions if an application requires it.

As to database storage and processing, the data may be written to a database 33, 78 and processed with a computer or processor. For example, system 10 could be instructed to watch for a person/cell phone of interest and generate an alarm with an automated watchlist check 32 and alert interface 42. Likewise, one could search archives to find every instance of a person based upon certain criteria such as cell phone 52 detection and an appearance model. These items do not necessarily have to be performed in the noted order. For example, a surveillance system watching for a particular individual may first perform identification (e.g., the subject of interest is within range) and then perform direction finding and location. In contrast, an intrusion detection system watching for unauthorized entry into an area may perform the direction finding and location first, and if the person has crossed the boundary, then system 10 may perform an identification (via a cell phone 52) to determine if it was an authorized or unauthorized subject.

The direction finding and location may be performed in several ways. One way is that one Doppler antenna 13, 19, 53, 54, 63, 64, 83, 84 may be used to find the direction while the camera angle is used to bound the distance and movement of the targeted individual to the camera 14, 18, 55, 65, 71. If the camera provides auto-focus and zoom capability, the distance information may be extracted from the camera and used in the range calculations. Another way is that two or more Doppler antennas may be used to identify the direction relative to the locations of the multiple antennas using a triangularization technique. An intersection of the received beams may then be used to locate the source of the RF transmission.

Other direction finding and location techniques may be used in the system 10. For example, received signal strength information from multiple receivers may be used. It may also be possible to use the time difference of signal arrival. The direction finding and location techniques may often be used in asset tracking systems to locate RF tags specifically designed to support RF location systems. The present system 10 may apply these techniques to cell phones 52 to support security applications.

System 10 may involve obtaining reliable forensics in cluttered environments. The system may address several military capabilities. One is target discrimination. For instance, the wars in Iraq and Afghanistan, as well as the war on terror, have shown that the enemy does not wear uniforms or drive vehicles while wearing their insignia. A serious question faced by soldiers in urban combat and peace-keeping missions may be which people or vehicles are the enemy. System 10 may apply a combination of RF signatures of cell phones 52 and other equipment, biometrics, appearance models, vehicle identification and tracking (forward and reverse) across non-overlapping sensors (i.e., RF and video) in order to identify potential threats and targets within the urban clutter.

Variants of tracking may be another capability of system 10. The system may provide both forward and backward tracking. Forward tracking may allow sensors to be tasked to follow a person or vehicle of interest. However, often one does not necessarily know who the person or the vehicle is until after an attack. The backward tracking capability may allow an operator or user to walk backwards through the sensor data to identify where the attacker came from and to identify potentially related contacts.

Another capability may be information fusion. Information silos may prevent one from obtaining the maximum benefit from various sources of information. This may relate to database 33, 78 and the virtual database interface 43. System 10 may combine information from multiple types of sensors such that the weakness of one sensor can be complemented by the strengths of another.

Another component level technology may include sensor coordination and fusion. System 10 may use a variety of sensors including PTZ video cameras, face finders, motion detectors, cell phone trackers and license plate readers of sensor field 11 and front end processing section 21. System 10 not only may correlate the data from the different sensors, but it may use the sensors to trigger tasking of other sensors. For example, relatively long range cell phone tracking may be used to detect the presence of a person of interest. Using direction finding, the system may slew a camera to the target and obtain a video of it. This may also allow capture of license plate data via the OCR reader 22.

Watchlist checking may be another component level technology with the automated watchlist check module 32. Data collected by the sensors may be automatically checked against a watchlist and users may be notified of the location and time that a person, vehicle or cell phone of interest was observed, with the alert interface 42.

There may also be distributed processing. Bandwidth may be limited within the urban battle space. Therefore, system 10 may make use of on-sensor processing. For example, onboard analytics 26 on the cameras 14 may perform motion detection, people detection and license plate OCR reading with video analytics module 26 and OCR reader 22, respectively. This approach may reduce and limit the amount of bandwidth consumed in moving raw sensor data from sensor field 11. System 10 may use a cell-based architecture with each cell 51, 61 providing its own sensors of a sensor field 11, and sensor control, e.g., steerer 25, and video analytics 26 of processing section 21, and a database 33 of section 31. This approach may permit multiple cells 51, 61 to be deployed while supporting distributed queries with query interface 44 via virtual database interface 43 to other cells, and alerts via interface 42.

The performance metrics for the system may include operational and functional performance. Operational metrics may include tracking and watchlist matching. Tracking may indicate an ability to trace the movements of a person or vehicle. Watchlist checker module 32 may indicate how many persons or vehicles are matched to a watchlist. Functional metrics may include resolution of cell phone location and reverse tracking speed and accuracy. Resolution of cell phone location may include the amount (i.e., percentage) of time that system 10, with direction/location finder 24, phone number extractor 23 and video analytics 26 of processing section 21, needs to link a cell phone 52 to an individual or vehicle.

Cell phone 52 direction/location finding may include another component technology. Associating a person and vehicle with a cell phone signal may provide additional intelligence to identify social networks and to discriminate targets at a distance. There may be various approaches for using one or more antennas 13, 19, 53, 54, 63, 64, 83, 84 to locate a source of a signal and also to extract handset identification from the signal.

Another phase of system 10 may include integrating the components into an operational surveillance tracker. One aspect may be integrated sensor tasking. This aspect may link the sensors such that detection by one sensor will tie in one or more other sensors. For example, the camera may be tasked based upon a location signal from the Doppler system and feedback from the video analytics 26. The analytics may be used to compensate for error in the Doppler location and distinguish multiple people within a field of view.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. An integrated tracking and surveillance system comprising:
an image sensor for video surveillance; and
a radiation detector for tracking a radiation source.

2. The system of claim 1, wherein the radiation source is a cell phone.

3. The system of claim 2, wherein the radiation detector comprises at least one direction sensitive antenna.

4. The system of claim 1, wherein the radiation detector comprises one or more direction sensitive antennas for at least either determining direction or location of a radiation source.

5. The system of claim 1, wherein the image sensor is a camera for being steered towards the radiation source as indicated by the radiation detector.

6. The system of claim 5, wherein:
the radiation source is a cell phone;
the radiation detector is for detecting or identifying the cell phone, or for both detecting and identifying the cell phone;
the camera is for obtaining video images of an entity associated with the cell phone; and
the video images are at least of visible light or infrared light, or both visible and infrared light.

7. The system of claim 1, further comprising a track correlation mechanism for correlating a track of a moving radiation source with a track of an entity in an image of the image sensor in order to associate the radiation source and the entity in cluttered environments.

8. The system of claim 1, wherein:
the system comprises a two or more cells; and
a cell comprises:
one or more radiation detectors; and
one or more image sensors.

9. A surveillance and tracking system comprising:
a sensor field; and
a processing section connected to the sensor field; and
wherein:
the sensor field comprises:
one or more cameras; and
one or more electromagnetic radiation antennas; and
the processing section comprises:
an electromagnetic radiation receiver connected to the one or more radiation antennas; and
a video analytics module connected to the one or more cameras.

10. The system of claim 9, wherein:
the radiation receiver and the one or more electromagnetic antennas are for tracking a source of electromagnetic radiation; and
the one or more cameras are for capturing video images of the source, or an entity or entities associated with the source.

11. The system of claim 10, wherein:
the source of electromagnetic radiation is a cell phone; and
the processing section further comprises:
a identification extractor connected to the receiver for extracting information identifying the cell phone; and
a finder connected to the radiation receiver for determining either a direction or a location or both the direction and location of the source of electromagnetic radiation.

12. The system of claim 11, further comprising:
a database function section connected to the processing section; and
wherein the database function section comprises:
a module for sensor/data correlation and database updates, connected to the identification extractor, video analytics module and the electromagnetic radiation receiver; and
a database connected to the module for sensor/data correlation and database updates.

13. The system of claim 12, further comprising:
an interface section connected to the database function section; and
wherein:
the interface section comprises:
a database interface connected to the database; and
the database interface is for providing an interface between the database and other entities.

14. The system of claim 13, wherein:
the database function section further comprises a watchlist checker; and
the interface section further comprises an alert interface connected to the watchlist checker.

15. The system of claim 14, wherein the interface section further comprises a query interface connected to the database interface.

16. A method for surveillance and tracking comprising:
tracking electromagnetic emissions from a movable source;
determining a direction or location of the movable source; and
performing video surveillance in the direction of or proximate to a location of the movable source.

17. The method of claim 16, further comprising seeking an identity of the movable source.

18. The method of claim 16, further comprising seeking identification of an entity associated with the movable source.

19. The method of claim 16, further comprising performing video analytics on an object or person in images from the video surveillance, for obtaining information about the object or person.

20. The method of claim 16, wherein the movable source is a cell phone.
